(19) United States
(12) Patent Application Publication
(10) Pub. No.: US 2007/0292218 A1
(43) Pub. Date: Dec. 20, 2007

(54) DYNAMIC BLOWER SYSTEM, AND METHODS OF CONSTRUCTING AND UTILIZING SAME

(76) Inventor: ROBERT JOHN SUCHEY, Vanderbilt, MI (US)

Correspondence Address: Irving M. Weiner;Weiner & Burt, P.C., 635 N. US-23, P.O. Box 186, Harrisville, MI, 48740, US

(21) Appl. No.: 11/763,012

(22) Filed: Jun. 14, 2007

Related U.S. Application Data
(60) Provisional application No. 60/804,895, filed on Jun. 15, 2006.

(51) Int. Cl. B65G 53/66

(52) U.S. Cl. 406/14

(57) ABSTRACT

An apparatus for applying a shredded foil radiant barrier on top of existing attic insulation. The foil is spun in an air vortex created in a tank, and is blown from there via a hose/applicator to a remote attic. A conical component in the tank helps to establish and maintain the vortex, and to minimize leaving shredded foil in the bottom of the tank.

### CROSS-REFERENCE TO RELATED APPLICATIONS

The present application claims priority from and is a continuation-in-part of U.S. Provisional Patent Application Ser. No. 60/804,895 filed on Jun. 15, 2006.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to a novel and unique dynamic blower system, and methods of constructing and utilizing same.

More particularly, the present invention relates to a dynamic blower system for applying a shredded foil radiant barrier, and a methods of constructing and using same.

The prior, but not necessarily relevant, art is exemplified by:

Palmquist et al. U.S. Pat. No. 3,591,400;

Tung U.S. Pat. No. 3,802,944;

Hardesty U.S. Pat. No. 4,776,142;

Hebert et al. U.S. Pat. No. 6,892,909

Liou U.S. Pat. No. 6,916,149; and

Gerber U.S. Pat. No. 6,964,543.

It is a desideratum of the present invention to avoid the animadversions of the prior art and conventional apparatuses and systems, and to provide a novel and unique easy-to-use dynamic blower system.

### BRIEF SUMMARY OF THE INVENTION

The present invention provides a dynamic blower system for applying a blowable material, comprising a tank into which the blowable material may be loaded; first means operable interconnected with said tank for generating an air vortex in said tank, which air vortex causes said blowable material to enter and spin with said vortex; an output hose applicator operably interconnected with said tank; and second means operably interconnected with said tank and positioned relative to said vortex to direct the spinning material into and through said output hose applicator to enable a user to apply the blowable material where desired.

The present invention also provides a method of applying a shredded foil radiant reflective barrier, comprising the steps of: supplying shredded foil to a tank; generating an air vortex in said tank; causing said air vortex to pick up said shredded foil to spin with the vortex in said tank; directing the spinning shredded foil to move through output applicator means; and forming the shredded foil radiant reflective barrier by applying the shredded foil with the output applicator means.

The present invention provides a dynamic blower system for blowing shredded foil or any other media as described and illustrated hereinbelow.

It is an object of the present invention to provide a dynamic blower system as described and illustrated hereinbelow which will easily fit or pass through any door in a home or commercial building.

Another object of the present invention is to provide a blower system which can apply shredded aluminum foil, radiant barrier, or any other media on top of existing attic insulation, which foil, barrier, or other media, reflects heat away from said insulation in summer, reflects heat back to said insulation in winter preventing heat from escaping, and will allow moisture to pass therethrough.

Other objects, advantages, features and modifications of the present invention will become more apparent to those persons skilled in this particular area of technology and to other persons after having been exposed to the present patent specification with its accompanying drawings.

### BRIEF DESCRIPTION OF THE SEVERAL VIEWS OF THE DRAWINGS

FIG. 1 shows an elevational perspective view, partly in section, of a first embodiment of the invention,

FIG. 2 is a sectional view taken along the plane 2-2 of the FIG. 1 embodiment.

FIG. 3 is a view of the type of shredded media applied by the FIG. 1 embodiment.

FIG. 4 is a fragmentary view of a radiant barrier applied by the invention on existing attic insulation.

FIG. 5 is a perspective view of a second embodiment of the invention shown with the lid opened.

FIG. 6 is a perspective view of the FIG. 5 embodiment shown with the lid closed.

### DETAILED DESCRIPTION OF THE INVENTION

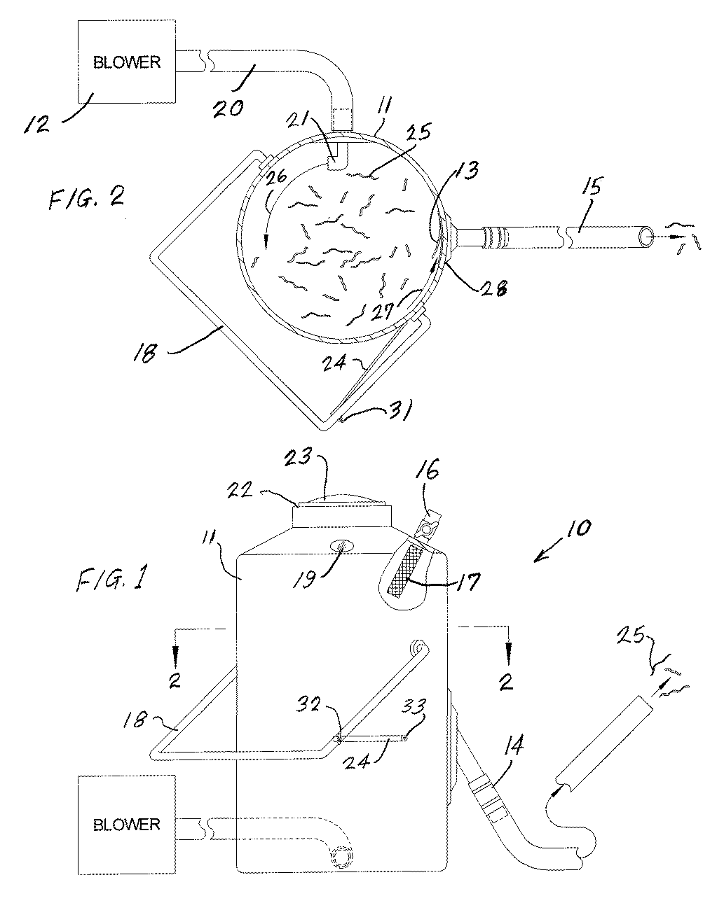

With reference to FIGS. 1 and 2, there is shown a dynamic blower system 10 in accordance with a first embodiment of the present invention.

The system 10 includes a tank 11, a power blower unit 12, media scoop 13, a quick connect/disconnect device 14, an output hose/applicator 15, an air exhaust lift control valve 16, an air and particulate filter 17, a folding kickstand 18, a view port 19, a blow pipe 20, a circulating nozzle 21, a loading port 22, a fill cap 23, and a kickstand latch device 24.

Media to be blown and/or applied is loaded into the tank 11 via the loading port 22.

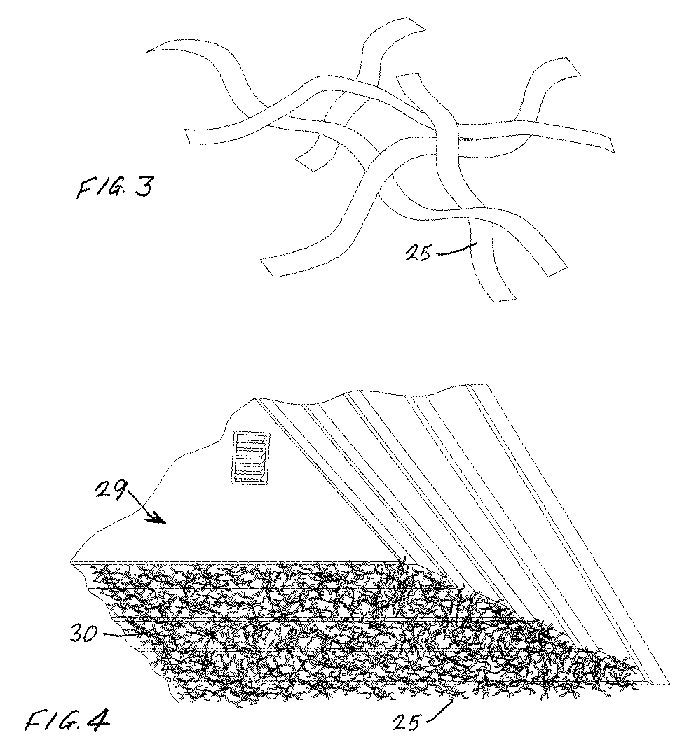

Preferably, but not necessarily, the media may take the form of shredded aluminum foil 25 as shown in FIGS. 2, 3 and 4.

The fill cap 23 serves to prevent foil 25 from being blown out of the loading port 22.

The viewing port 19 enables the user to determine if re-filling of the tank 11 is needed.

The power blower unit 12 directs a high pressure stream of air into the tank 11 via blow pipe 20 and circulating nozzle 21 creating a spinning air vortex in tank 11.

Preferably, but not necessarily, the nozzle 21 is movable and/or positionable within tank 11 to achieve the desired vortex.

The air vortex spins the shredded foil 25 in the direction of arrows 26 and 27.

The shredded foil 25 spins into media scoop 13 which directs the foil 25 out through the outlet port 28 and into the quick connect/disconnect device 14 and output hose/applicator 15.

Preferably, but not necessarily, the output hose applicator 15 can include a very lengthy hose to enable the user to position the tank 11 where convenient and/or desired, and yet easily reach a distant attic 29 (FIG. 4) for applying therein a radiant reflective barrier 30 of shredded foil 25.

Preferably, but not necessarily, the device 14 can be a flexible device.

Preferably, but not necessarily, the valve 16 may take the form of an adjustable relief valve.

The kickstand 18 allows the tank 11 to be tilted during operation.

Preferably, but not necessarily, the kickstand latch device 24 may be provided with a pivot connection 33 to the tank 11, and a hook 31 which can hook over a wing nut 32 on the kickstand 18.

The system 10 permits the user to easily, quickly, and very conveniently apply a shredded foil radiant barrier 30 to not-so-readily-accessible areas, such as, an attic 29.

The radiant barrier 30, which can be placed on top of existing home insulation, will reflect approximately 96% of the radiant heat.

In addition, the barrier 30 is non-flammable, fully breathable, and does not cause any condensation problem.

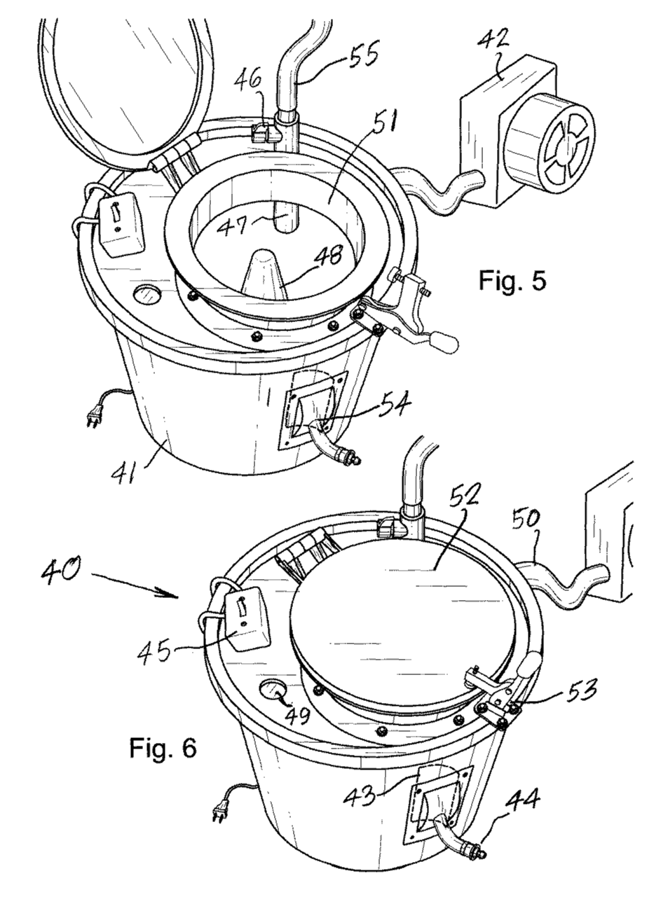

With reference to FIGS. 5 and 6, there is illustrated a second embodiment in the form of a dynamic blower system 40 which operates substantially similar, but not identical, to the system 10 described hereinabove.

The system 40 includes a tank 41, a power blower unit 42, media scoop or internal directional louver 43, a quick connect/disconnect device 44, an output hose/applicator (not shown in FIGS. 5 and 6, but similar to hose/applicator 15 shown in FIG. 2), a blower control switch 45, an adjustable air valve 46, an air and particulate filter 47, a conical member 48, a view port 49, a blow pipe 50, a circulating nozzle (not shown in FIGS. 5 and 6, but similar to nozzle 21 shown in FIG. 2), a loading port 51, a lid 52, an adjustable lock latch 53, an output port 54, and a hose 55 for venting and assisting to lift the shredded foil 25 in the tank 41

Media to be blown and/or applied is loaded into the tank 41 via the loading port 51.

Preferably, but not necessarily, the media may take the form of shredded aluminum foil 25 as shown in FIGS. 2, 3 and 4.

The lid 52 serves to prevent the shredded foil 25 from being blown out of the loading port 51.

The viewing port 49 enables the user to determine if re-filling of the tank 41 is needed.

The power blower unit 42 directs a high pressure stream of air into the tank 41 via the blow pipe 50 and circulating nozzle creating a spinning air vortex in tank 41.

The conical member 48 assists in establishing and maintaining the vortex, and minimizes accumulation of the shredded foil 25 remaining in the tank 41.

It is important to note that the present invention provides a blower system which can apply shredded aluminum foil, radiant barrier, or any other media, on top of existing attic insulation, which foil, barrier, or other media reflects heat away from said insulation in summer, reflects heat back to said insulation in winter preventing heat from escaping, and will allow moisture to pass therethrough.

While the foregoing describes only exemplary embodiments of the present invention, it is to be understood that the present invention covers all variations, modifications and changes thereof which will occur to those persons skilled in the art and to other persons after having been exposed to the present patent application.

1. A dynamic blower system for applying a blowable material, comprising:
a tank into which the blowable material may be loaded;
first means operable interconnected with said tank for generating an air vortex in said tank, which air vortex causes said blowable material to enter and spin with said vortex;
an output hose applicator operably interconnected with said tank and
second means operably interconnected with said tank and positioned relative to said vortex to direct the spinning material into and through said output hose applicator to enable a user to apply the blowable material where desired.

2. The dynamic blower system according to claim 1, including:
stationary means positioned in a bottom portion of said tank to assist in establishing and maintaining said vortex, and to minimize accumulation of the blowable material remaining in said tank.

3. The dynamic blower system according to claim 2, wherein:
said stationary means has a shape substantially like a nappe of a cone.

4. The dynamic blower system according to claim 1, including:
air filter means extending into said tank.

5. The dynamic blower system according to claim 2, including:
air filter means extending into said tank.

6. The dynamic blower system according to claim 3, including:
air filter means extending into said tank.

7. The dynamic blower system according to claim 1, wherein:
said first means includes an air input port with directional control at an interior surface of said tank at a bottom portion of said tank.

8. The dynamic blower system according to claim 2, wherein:
said first means includes an air input port with directional control at an interior surface of said tank at a bottom portion of said tank.

9. The dynamic blower system according to claim 3, wherein:
said first means includes an air input port with directional control at an interior surface of said tank at a bottom portion of said tank.

10. The dynamic blower system according to claim 4, wherein:
said first means includes an air input port with directional control at an interior surface of said tank at a bottom portion of said tank.

11. The dynamic blower system according to claim 5, wherein:
said first means includes an air input port with directional control at an interior surface of said tank at a bottom portion of said tank.

12. The dynamic blower system according to claim 6, wherein:
said first means includes an air input port with directional control at an interior surface of said tank at a bottom portion of said tank.

13. The dynamic blower system according to claim 4, including:
an adjustable air valve operably and physically interconnected with said air filter means; and
a vent hose connected to said air filter means for venting and for assisting in lifting said blowable material.

14. The dynamic blower system according to claim 5, including:
an adjustable air valve operably and physically interconnected with said air filter means; and
a vent hose connected to said air filter means for venting and for assisting in lifting said blowable material.

15. The dynamic blower system according to claim 6, including:
an adjustable air valve operably and physically interconnected with said air filter means; and
a vent hose connected to said air filter means for venting and for assisting in lifting said blowable material.

16. The dynamic blower system according to claim 10, including:
an adjustable air valve operably and physically interconnected with said air filter means; and
a vent hose connected to said air filter means for venting and for assisting in lifting said blowable material.

17. The dynamic blower system according to claim 11, including:
an adjustable air valve operably and physically interconnected with said air filter means; and
a vent hose connected to said air filter means for venting and for assisting in lifting said blowable material.

18. The dynamic blower system according to claim 12>including:
an adjustable air valve operably and physically interconnected with said air filter means;
a vent hose connected to said air filter means for venting and for assisting in lifting said blowable material;
an internal louver forming part of said second means; and
a viewing port disposed in an upper portion of said tank enabling a user to determine if re-filling of the blowable material into said tank is needed.

19. A method of applying a shredded foil radiant reflective barrier, comprising the steps of:
supplying shredded foil to a tank;
generating an air vortex in said tank;
causing said air vortex to pick up said shredded foil to spin with the vortex in said tank;
directing the spinning shredded foil to move through output applicator means; and
forming the shredded foil radiant reflective barrier by applying the shredded foil with the output applicator means.

20. The method of applying a shredded foil radiant reflective barrier, including the steps of:
filtering the air in said tank; and
venting air from said tank while assisting to lift said shredded foil in said tank.
